(19) United States
(12) Patent Application Publication
(10) Pub. No.: US 2002/0111860 A1
(43) Pub. Date: Aug. 15, 2002

(54) Method and system for payment of goods and/or services by the sponsor of an interposed communication on behalf of a consumer

(76) Inventor: Dana Howard Jones, Rancho Palos Verdes, CA (US)

Correspondence Address: MORRISON & FOERSTER, LLP, 555 WEST FIFTH STREET, SUITE 3500, LOS ANGELES, CA, 90013-1024, US

(21) Appl. No.: 09/932,714

(22) Filed: Aug. 17, 2001

Related U.S. Application Data
(60) Provisional application No. 60/227,096, filed on Aug. 22, 2000.

(51) Int. Cl. G06F 17/60

(52) U.S. Cl. 705/14; 705/26

(57) ABSTRACT

The present invention is directed to a method and system for distributing or obtaining incentives related to the purchase or acquisition of a product or a service, whereby the incentive can be offered on condition that the purchaser of the product or service agrees to receive an interposed communication, which can be any multimedia message including advertisement, informative information, or survey.

### CLAIM OF PRIORITY

The present application claims the benefit of U.S. Provisional Application No. 60/227,096, titled “Method and System for Payment of Goods And/Or Services by the Sponsor of An Interposed Communication, on behalf of A Consumer, Over A Telecommunications Network,” filed on Aug. 22, 2000.

### BACKGROUND OF THE INVENTION

1. Field of Invention

The present invention is directed to a method and system for distributing or for obtaining goods or services through alternative method of payment by an interposed advertiser or sponsor on behalf of a consumer.

2. Description of Related Art

Historically, a sponsor's (i.e., advertiser's) communication, be it a print advertisement, television commercial or Internet banner ad, has been a passive tool in the job of making consumers aware of the sponsor's products.

Consumers have had no duty to notice advertising. In fact, consumers spend a certain amount of energy avoiding commercials. The advent of cable television and the VCR (and recently the personal digital video recorder, or PVR) have enabled television viewers to either “channel surf” to other programs during commercial breaks, or fast forward through commercials when viewing shows that have been recorded. The PVR systems actually have 30-second instant skip-ahead buttons on the remote control—precisely the length of most commercials. And, with the shear number of simultaneous programs on at any given time, sponsors find it increasingly difficult to reach large numbers of people without buying several programs at once.

Sponsors have a difficult time knowing if their communications are heard and understood. For example, the Nielsen Ratings attempt to tell TV stations and sponsors how many people are watching any given show. They do this by selecting a small sample of representative people, whose television usage Nielsen monitors with a set-top box. However, when commercials come on and the channel is not switched, no one at Nielsen will know if the viewers left the room for a snack or a bathroom break.

Sponsors have similar difficulties measuring their audiences on the radio. Since the majority of the listeners are in their cars, the preset buttons on their radios allow for instant channel changing when ads come on. The main ratings service for radio, Arbitron, utilizes hand-written diaries to be filled out by a cross section of the population. Certainly a major problem of this method is that listeners cannot be filling out their diaries while driving, and are not noting their frequent station switching during commercial clusters.

Advertisers in newspapers and magazines have similar difficulties in measuring advertising readership. There is no one looking over the reader's shoulder to see how fast the pages are turning.

Only with the advent of the internet has the technology developed where exact or near exact usage habits by users can be tracked. The stats seem to prove that most advertising is ignored, regardless of the medium in which it is presented.

The results of internet banner ad “click-throughs” show an amazing lack of response. As of mid-July 2000 the average rate was 0.025%. For every 1,000 times a banner ad was served to web users, 997.5 times there was no response. And since no one is measuring eye movement of web users, it becomes impossible to guess how many people even notice the banner ad. It has become eye junk.

And for those two and half people per one thousand that do click-through from a banner to a sponsor's site, there is no guarantee that these people stay there long enough to have the sponsor's story told.

Besides the banner ad, some internet publishers offer advertisers more intrusive ad formats. These include so-called pop-up ads that appear unannounced, in their own “console” window within a browser. Again, the viewer has no obligation to view these ads, and can simply click the window's close button to get rid of them. A more refined approach is the interstitial ad, which appears between two loading pages. A specialized interstitial, the Superstitial™ by Unicast, loads in the background of a currently viewed page. When a viewer decides to go to a subsequent page, the Superstitial™ pops up in between, instantly. Because these ad formats are never requested by the viewer, they tend to be considered more of an annoyance than a positive form of advertising, and are quickly clicked away.

It is clear that sponsors and/or advertisers are without a guaranteed way to tell their whole story to the consumers they wish to reach, in a format that monopolizes the consumer's attention, and in which the consumer is a willing participant.

Goldhaber, et al (U.S. Pat. No. 5,794,210) offers “cyber coin” compensation for paying attention to online advertisements and the brokerage of attention. Specifically, CyberGold (owner of the above-mentioned patent) sends frequent e-mails to members offering five cents to visit their clients' sites. At that rate, it requires a lot from the consumer to accumulate enough money to be able to make a purchase—and then only from their list of providers. CyberGold does offer to “cash out” their members' accounts to member's checking or Visa accounts.

The website www.freeride.com offered points to consumers to view their client's websites. After accumulating points, consumers may redeem the points for goods and services at participating vendors. This is a three-step process, where 1) consumers must sign-up, 2) visit the required sites to earn enough scrip, then 3) visit other participating sites to redeem their script for only those goods and/or services being offered. Participants rarely can accumulate enough scrip within one online session to make a purchase, thus requiring several days worth of clicking to get sufficient scrip for goods and/or services.

Similar “incentive” businesses, like netcentives.com (U.S. Pat. No. 5,774,870, Thomas W. Storey) and mypoints.com operated similar business models, with multi-step processes for consumers to earn points that are convertible for purchases at member sites. Often, points are only rewarded after a consumer makes a purchase at a client site, or performs some other pre-determined action, like filling out a survey, or trading their personal information for points.

None of these patents or sites offer direct one-step payment methods by an interposed sponsor for purchases of goods and/or services that the consumer was planning to purchase anyway.

Many young people under the age of 18 do not have a way to pay for items they find on the internet, because they are too young to have credit or debit cards. Older internet consumers may have these credit or debit cards, but have become accustomed to getting information, services, even music, for free over peer-to-peer networks. Copyright holders for this music, literature, art and information are not being compensated, as no purchase mechanism is in place to allow payments.

Credit card and debit card purchases over telecommunications networks (both internet and telephone) bring opportunities for fraud. Account numbers and personal information can be “hacked” by thieves who make fraudulent purchases or sell the account numbers they've gathered to others for illegal use.

Accordingly, there is a need for an alternate way to pay immediately for certain goods and services without credit or debit cards.

### SUMMARY OF THE INVENTION

The present invention turns an advertisement into a purchase enabler. In addition to others, three groups of parties benefit greatly from the present invention. First, consumers can make purchases over a telecommunications network (like the Internet, or a telephone system), via a kiosk, or any other remote purchase system without spending cash. Second, sponsors are given a willing consumer who will provide attention to the sponsor's communication in exchange for goods and services. And third, a vendor, who can distribute goods and/or services to consumers in a “cashless” method that can “feel” free.

In accordance with the preferred embodiments of the present invention, a consumer can receive incentives related to the purchase of goods and services after viewing, listening, and/or interacting with an interposed sponsor's communication that can be presented within a vendor's internet site, telephone based business, video-on demand network, in-store kiosk connected to a telecommunications network, or any other form of communication media.

Several objects and advantages of the present invention include:

a) to provide a one-step “money-less” way for consumers to legitimately obtain goods and services or discounts on goods and services over a telecommunications network;

b) to provide a legitimate alternative to the use of credit cards and debit cards over a telecommunications network;

c) to provide sponsors with a way to get their story told without interruption;

d) to provide sponsors with a way to get immediate feedback about their product or service;

e) to provide sponsors with a “captive audience” of a certain demographic profile for either a specified period of time or for a specified number of responses to advertisers' queries, yet respecting the privacy issues of the consumer;

f) to provide certain side benefits, such as enacting a greater number of sales because the consumer's resistance to the interposed communication may prove to be lower than their resistance to spending cash.

### BRIEF DESCRIPTION OF THE DRAWINGS

FIGS. 1a through 1g show a schematic diagram of a method of obtaining/distributing products in accordance with the preferred embodiment of the present invention.

FIGS. 2a through 2f show a schematic diagram of a method of obtaining/distributing products in accordance with an alternative embodiment of the present invention.

FIGS. 3a through 3d show a schematic diagram of a method of obtaining/distributing services of monetary value in accordance another alternative embodiment of the present invention.

FIG. 4 shows a vendor/distributor maintaining documents and agreements relating to the consumer and sponsor in accordance with one aspect of the present invention.

FIGS. 5a through 5d show a schematic diagram of a method of obtaining/distributing telephone service in accordance with another alternative embodiment of the present invention.

FIGS. 6a through 6b show a schematic diagram of a method of obtaining/distributing video products in accordance with another alternative embodiment of the present invention.

FIGS. 7a through 7c show the supply and demand of available interposed communications and consumers, and how fluctuations in supply and demand are handled within the present invention.

FIGS. 8a through 8c show another alternative embodiment of the present invention wherein a vendor offers consumers the opportunity to sign up for an opt-in e-mail notification system wherein consumers will be told when interposed communications are available to enable purchases at vendor's purchase point of transaction.

FIGS. 9a through 9b show a schematic diagram of a method of obtaining/distributing interposed communication in accordance with another alternative embodiment of the present invention.

FIGS. 10a through 10e show a schematic diagram of a method of obtaining/distributing products or services using a kiosk in accordance with another alternative embodiment of the present invention.

FIGS. 11a through 11d show a schematic diagram of a method of obtaining/distributing products or services in accordance with another alternative embodiment of the present invention.

FIG. 12 show a schematic diagram of a method of obtaining/distributing products or services in accordance with another alternative embodiment of the present invention.

FIGS. 13a through 13d show additional embodiment of the present invention wherein the only choice for payment is the sponsored interposed communication.

FIGS. 14a through 14c show the specific minimum qualities the sponsored interposed communication must have.

### DETAILED DESCRIPTION OF THE PREFERRED AND ALTERNATIVE EMBODIMENTS

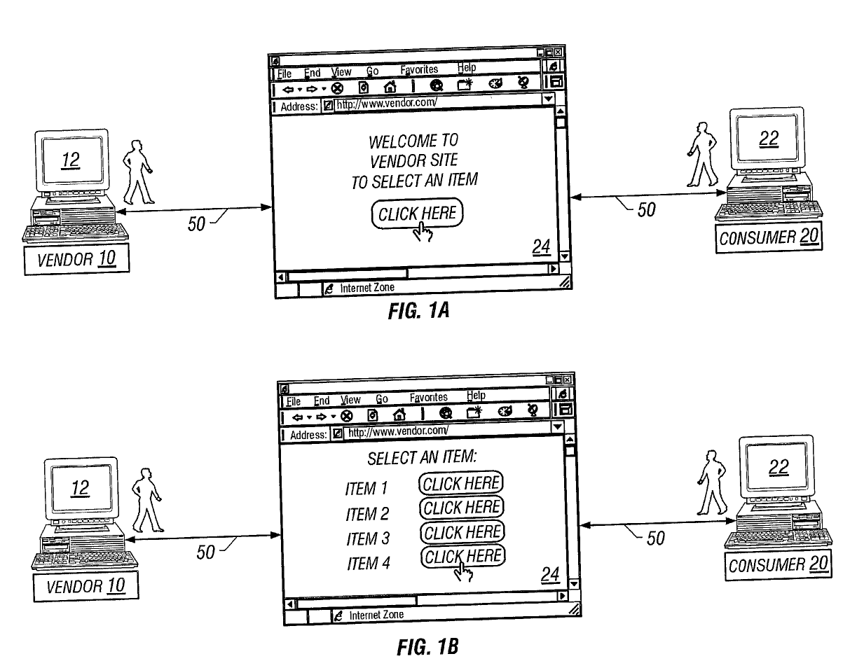

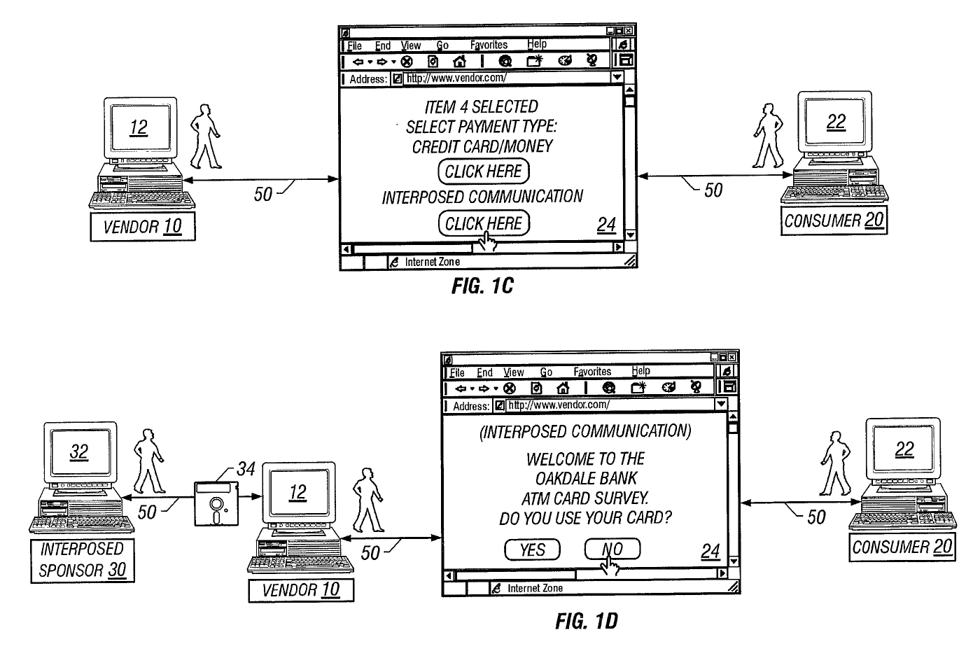

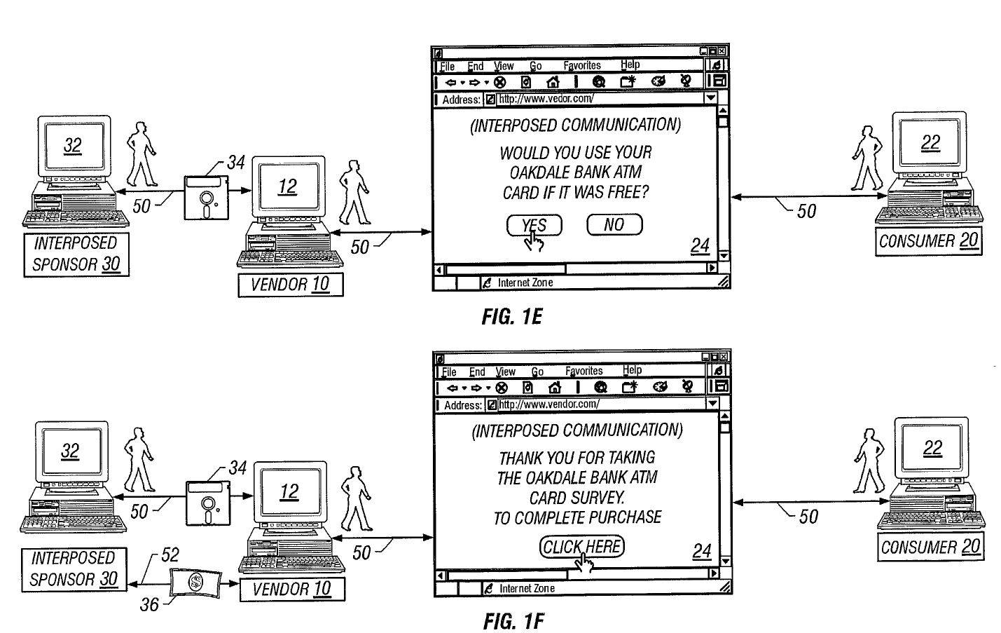

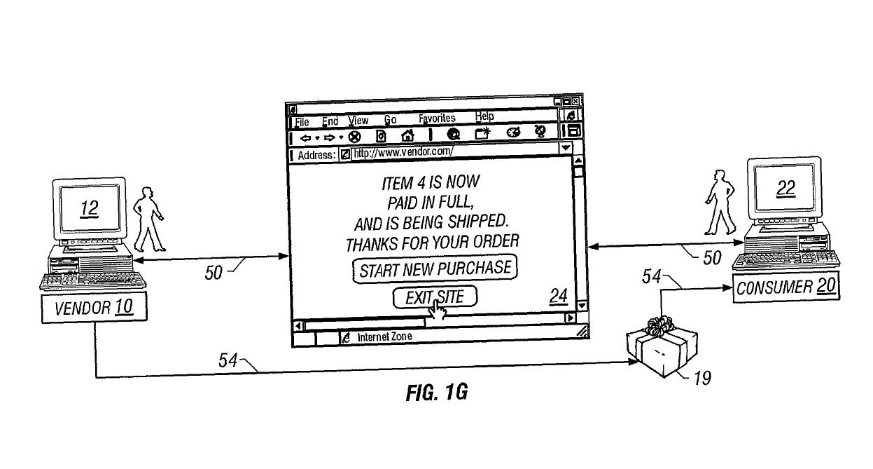

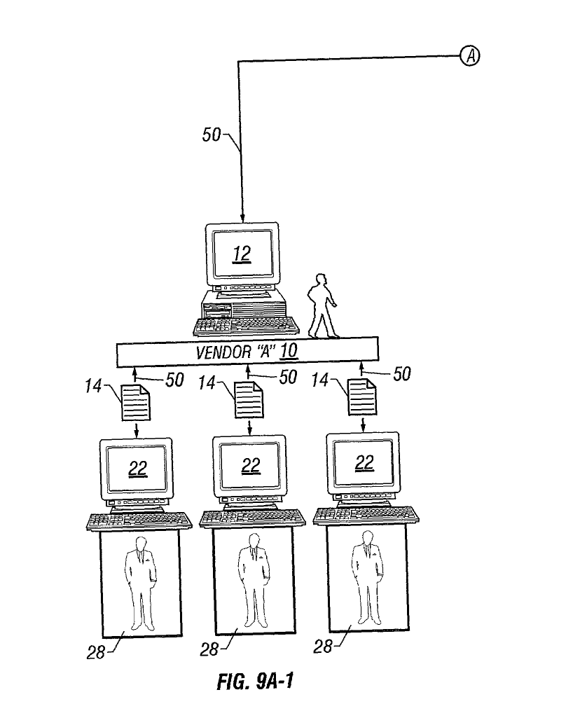

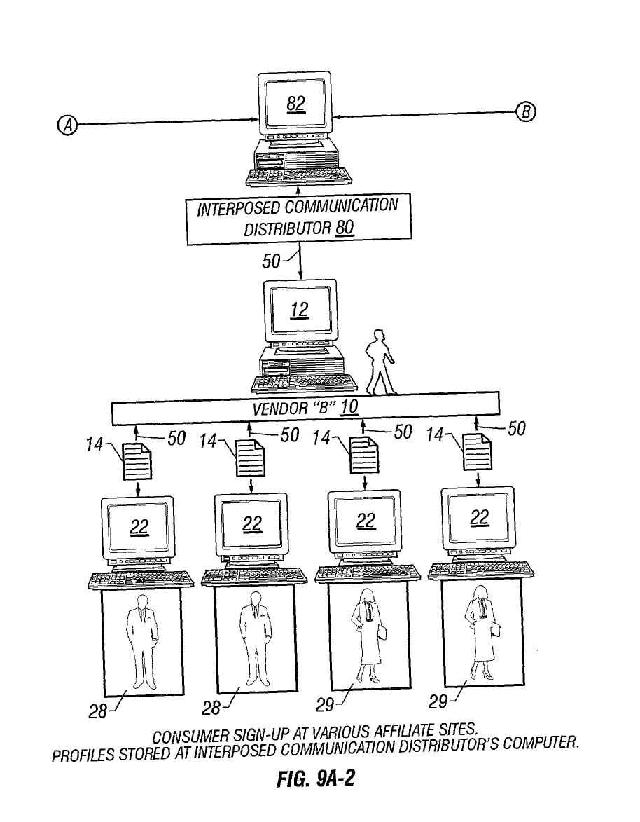

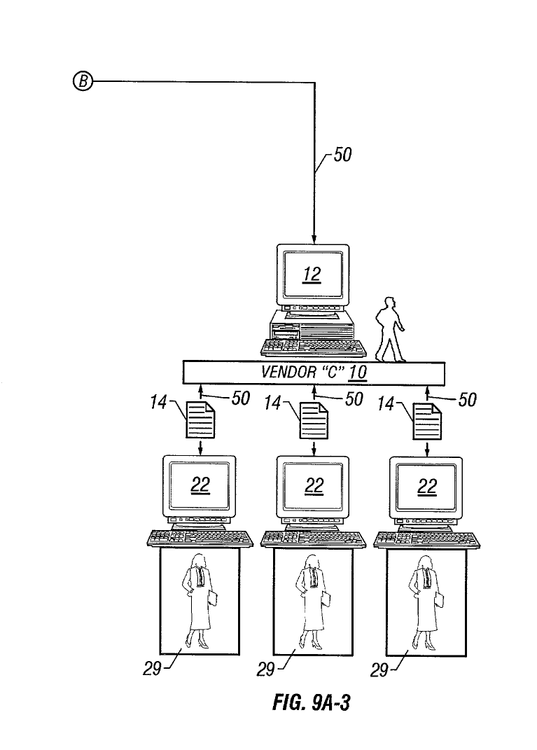

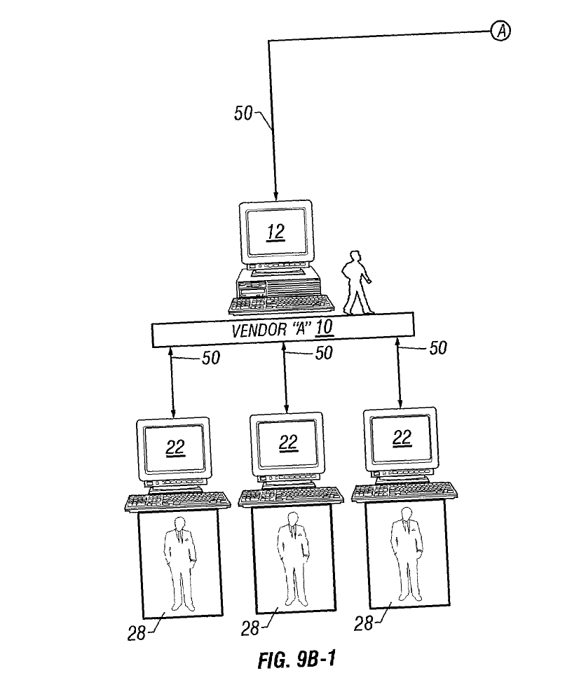

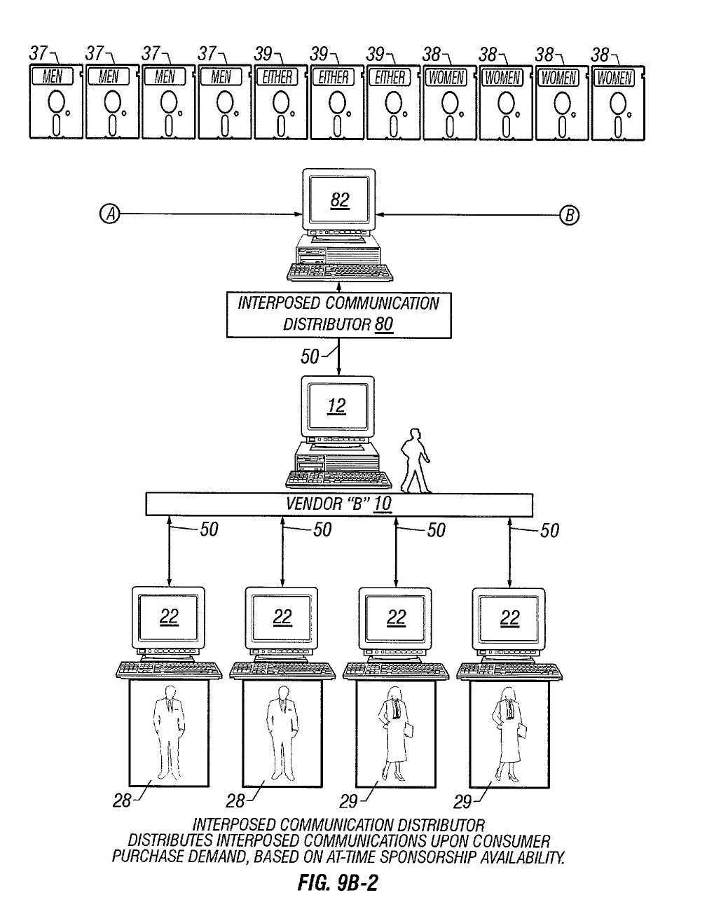

The embodiments of the present invention shall be described in detail with references to FIGS. 1-14C. It should be understood that the detailed discussions of the preferred and alternative embodiments are not intended to limit the present invention to those particular embodiments.

FIGS. 1A through 1G show one cycle of distributing/obtaining product or services in accordance with the preferred embodiment of the present invention. Specifically, FIG. 1A shows a vendor 10 and a consumer 20 communicating by use of their respective computers (vendor's computer 12, consumer's computer 22) over a telecommunications network 50, comprising a plurality of computers with at least one vendor computer 12 and one consumer computer 22. Vendor's website is preferably displayed in the consumer's Internet browser window 24. Vendor's computer 12 may be physically located off-site from vendor's place of business, hosted by a third party on third party's computer. Similarly, the consumer's computer 22 may not be owned by the consumer or physically located at the consumer's home or business. It may be a community computer available for public use at a public place.

FIG. 1A shows vendor's welcome page that prompts for a consumer to begin the selection of an item for purchase. FIG. 1B shows in the browser window 24 four items from which the consumer may select for purchase. In this example, consumer selects Item 4. FIG. 1C shows the vendor offering two methods for payment: credit card or interposed communication. In this example, the consumer has selected the interposed communication. Preferably, but not necessarily, the vendor has shown a money value for the item to be purchased. In this way the consumer can decide whether to pay by money or by interacting with the interposed communication. The consumer can then see how much his or her time and attention are worth, and make his or her choice.

FIG. 1D shows the interposed sponsor 30 and his/her computer 32, also attached to the said telecommunications network 50. After the consumer makes the choice to view the interposed communication, the interposed sponsor provides to consumer an interposed communication 34, transmitted through vendor's computer 12 onto consumer's computer 22. It may be that with hyperlinking within the telecommunications network, and with HTML coding within the Vendor's computer 12 and the interposed sponsor's computer 32, that the interposed communication may be sent directly from the interposed sponsor's computer to the consumer's computer, bypassing the vendor's computer. The end result is identical: the consumer's browser screen is displaying the interposed sponsor's communication. The consumer is now expected to provide his or her attention to the sponsor's communication. It should be noted that any third party, including an advertisement agency, can be the provider of an interposed communication on behalf of the sponsor.

In the above example, a bank is the sponsor, and has decided to use the communication to query the consumer about their use of ATM cards. In accordance with the preferred embodiment, it is preferable that the consumer responds to the interposed sponsor's queries in order to fulfill the consumer's obligation to the sponsor prior to receiving the said goods and services. In accordance with the preferred embodiment, an opportunity for the consumer to cancel the interposed communication at any time and return to the payment options page of the vendor's site is preferably available. The consumer's response, if any, is then preferably sent back to the interposed sponsor or its designated agent, either directly or through a third party. As these responses are in real time, the interposed sponsor has immediate use of the answers to its queries. If the consumer does not complete watching or interact with the interposed communication, then the consumer forfeits any incentives or rewards that were being offered by either the vendor or the interposed sponsor.

FIG. 1E shows a second query being posed to the consumer. By asking questions to the consumer, the sponsor may gather valuable consumer information, and receive evidence that the consumer comprehends the content of the interposed communication. A vendor may regulate the number of queries or prompts a sponsor may place into their interposed communication, this said communication can have varying amounts of value. Specifically, more prompts equal greater value to the sponsor and greater purchasing power for the consumer. Of course, the sponsor could choose to have no queries placed in the communication.

FIG. 1F shows the conclusion of the interposed communication, and the payment of money 36 from the interposed sponsor to the vendor preferably through a two-way communications means 52 allowing for this transference of value. The timing of this payment in this step is to show that preferably the sponsor—not the consumer—who has pays vendor for the goods and/or services. It may be that the sponsor prepays the vendor for many interposed communications, perhaps on discount, or that the payment occurs much later, depending on the financial terms agreed to by both vendor and interposed sponsor.

Finally, FIG 1G shows that the consumer's obligation for payment is now complete. The vendor now sends the consumer the said selected item by a delivery system 54 which may be one or more of the following: mail, couriers (FedEx, UPS, etc.), telecommunications network, or other means to fulfill the order.

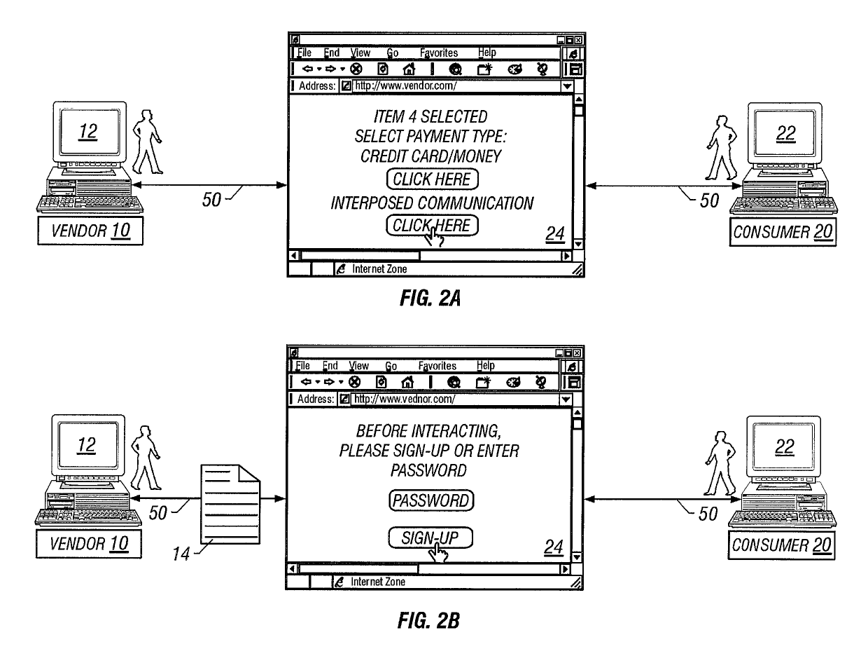

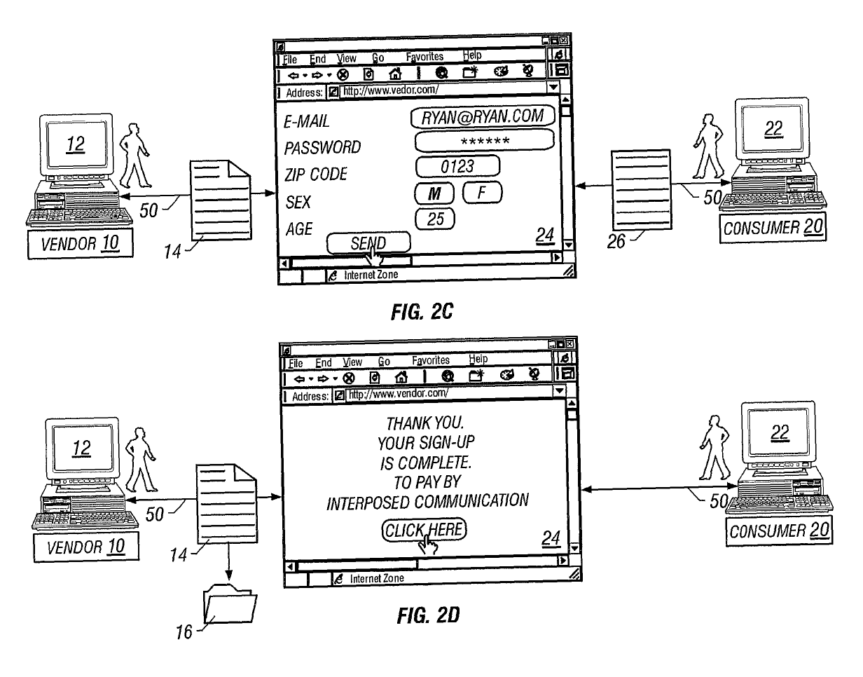

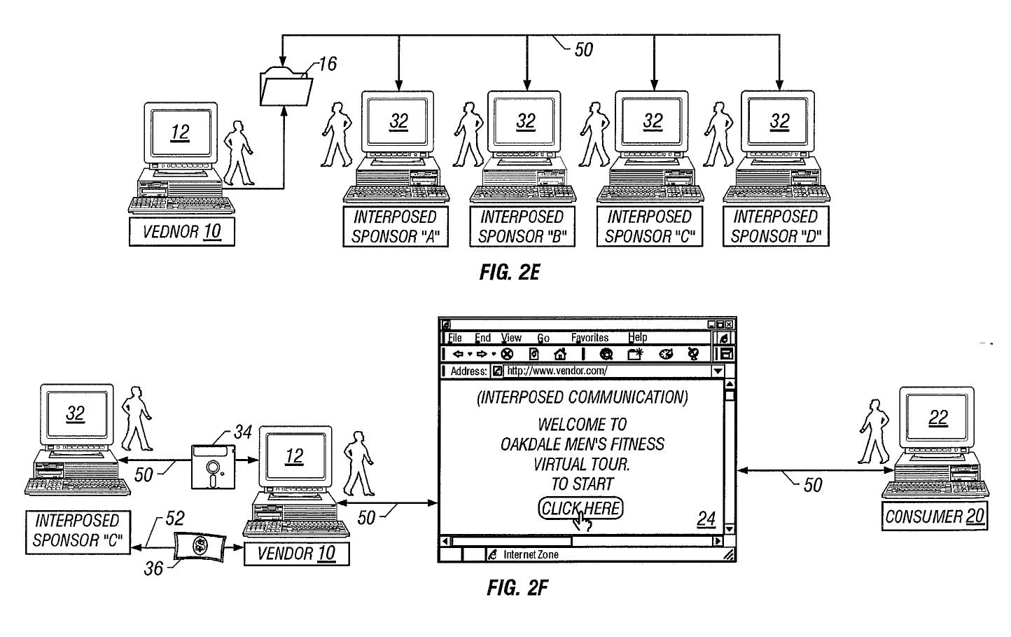

FIGS. 2A through 2F show a method of obtaining/distributing products or services in accordance with an alternative embodiment of the present invention. Specifically, FIG. 2A shows a similar purchase stage as shown in FIG 1C, as preparation to show an optional sign-up feature of the present invention. FIG. 2B shows that the consumer has been asked to either enter their pre-determined password, or complete a sign-up profile 14. In this example, the consumer has not yet signed up, and elects to do so. The consumer is also offered to the option of exiting this mechanism and returning to the previous screen, where the consumer may choose to pay by credit card or other money means.

FIG. 2C shows an example of sign-up profile questions. The reason for a signup profile can be three-fold. First, to better match the consumer with a variety of interposed sponsors. For instance, a sponsor with a man's product is wasting both his money and a woman consumer's time by presenting a male-oriented interposed communication to a woman consumer. A second reason for the sign-up profile may include creating a unique identity for said consumer so that the vendor can provide an accounting to the consumer of which interposed communications they've interacted with, which products have been purchased, and which sponsors would prefer not to repeat the same communication to this consumer. Divulging this information directly to sponsors is preferably not done. However, a vendor might offer consumer valuable consideration for the sale of their personal information. Thirdly, by signing up, consumer can be asked to agree to certain terms and conditions by which he/she will conduct themselves when utilizing the interposed communication as means to purchase. An example would be to avoid abuses of this system, including but not limited to posing as someone else to unjustly gain more purchases when none would otherwise be available, or posing as a consumer, when really a vendor, to enact false purchases to gain illegitimate sponsor money. Consumer preferably provides vendor with a unique password 25, which will allow consumer future access to this herein described purchase mechanism.

FIG. 2D shows the conclusion of the sign-up profile 14 and the start of selecting an appropriate interposed sponsor based on the data received in the consumer's profile 14, which is preferably placed into the consumer's use log 16. This log keeps track of which interposed communications the consumer has already seen. In FIG. 2E, vendor then queries available interposed sponsors 30“A”, 30“B”, 30“C”, or 30“D” in this example, as to which sponsor's predetermined criteria the consumer most closely matches. Within various embodiments, it may be that the vendor is already in possession of the interposed sponsor's communications, and can best determine which communication best suits the consumer, without direct queries to each sponsor.

Finally, FIG. 2F shows that in this example Interposed Sponsor “C”'s communication 34 best suits this consumer, and is preferably sent to the consumer's computer in the manner(s) previously described in 1d through 1f. Interposed sponsor's money 36 is preferably given to the vendor in the same manner(s) as described in 1f.

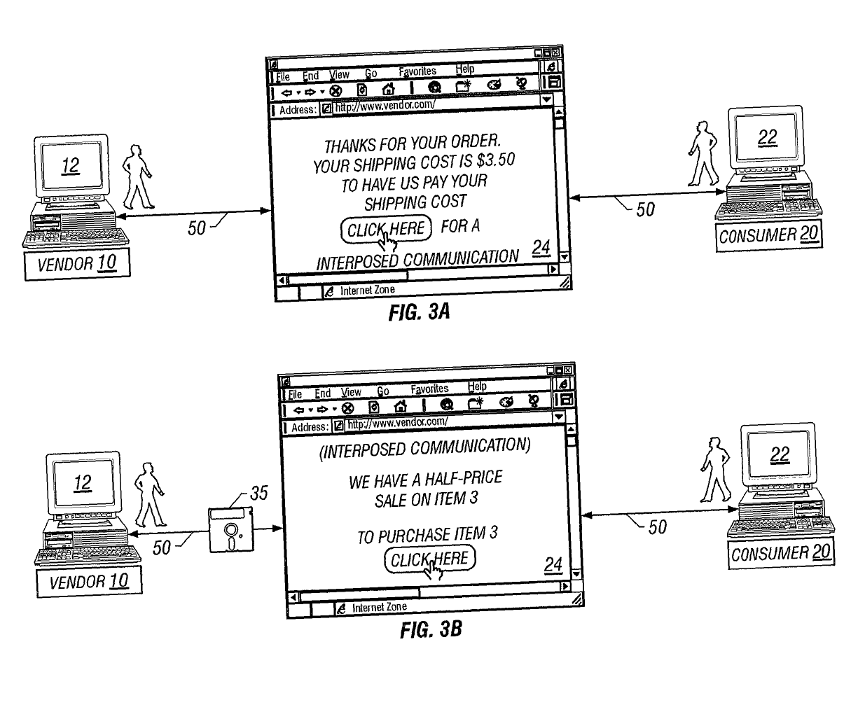

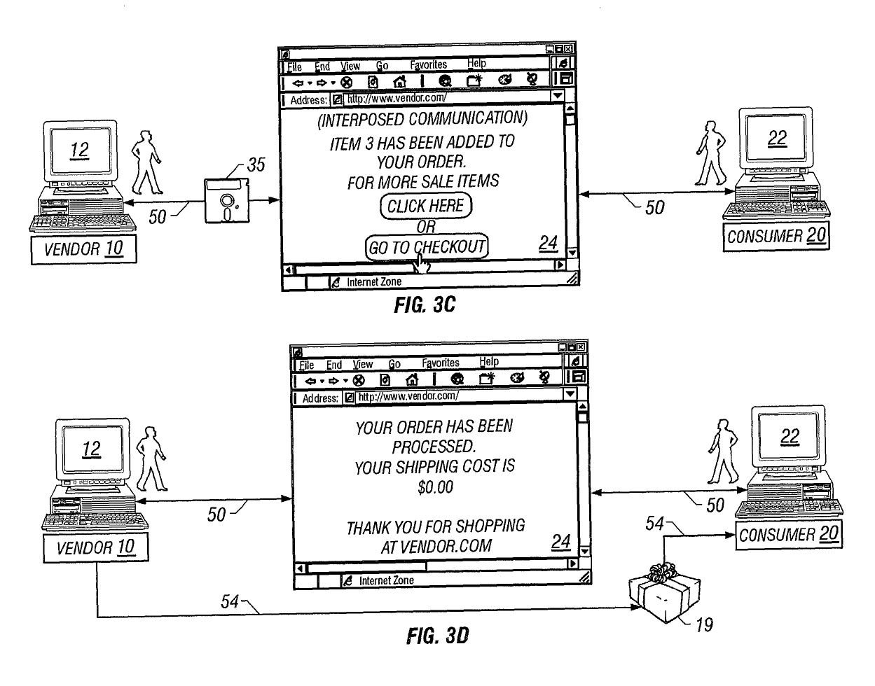

FIGS. 3A through 3D show a method of obtaining/distributing services of monetary value in accordance with another alternative embodiment of the present invention. Specifically, FIG. 3A and 3B show a vendor 10 offering the consumer 20 something of monetary value (in this case a shipping cost of $3.50) if consumer will view or interact with vendor's interposed communication 35. It is important to note that the interposed communication need not come from an outside third party sponsor. In this embodiment, the vendor may see value in further selling to the consumer, and likewise, the consumer would rather not pay money for the shipping charges and is willing to see the vendor's interposed communication 35.

FIG. 3B shows in this example that an additional item can be offered for sale, and, in this example, the consumer elects to add it to his/her order. FIG. 3C shows that vendor has received the consumers request to add item 3 to the order, and further options the consumer to continue shopping or go to checkout. Finally, FIG. 3D shows that the order has been processed, with the shipping charges being waived. Further, the goods and/or services 19 are being delivered by way of a delivery system 54, as outlined previously in FIG. 1G.

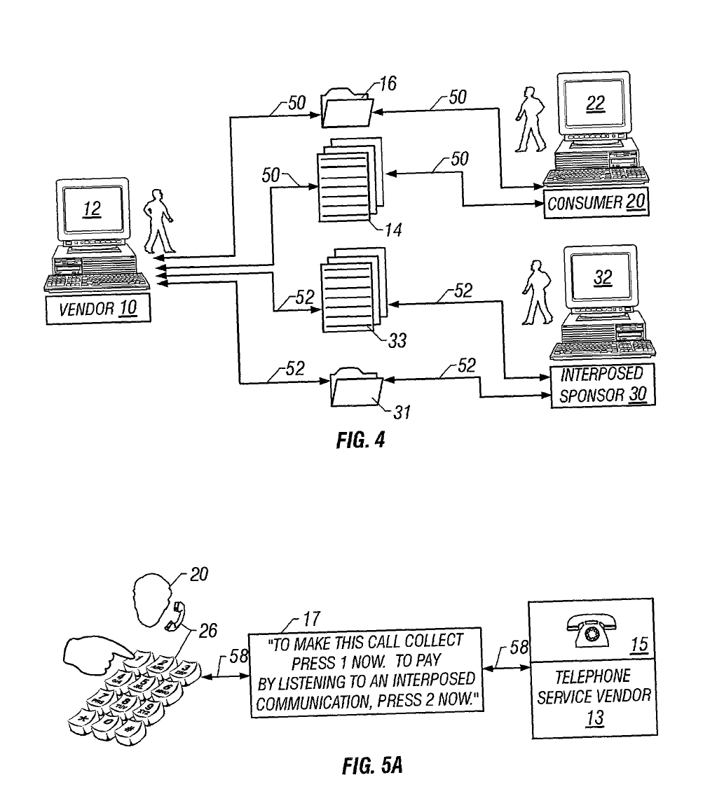

FIG. 4 shows that the vendor 10 preferably maintains two interactive documents (consumer use log 16, consumer sign-up profile 14) with the consumer 20, and two interactive documents (interposed sponsor use log 31, and interposed sponsor-vendor agreement 33 describing fees paid to vendor by sponsor to exhibit sponsor's interposed communication, and all other contractual items deemed necessary by both parties) with the interposed sponsor 30.

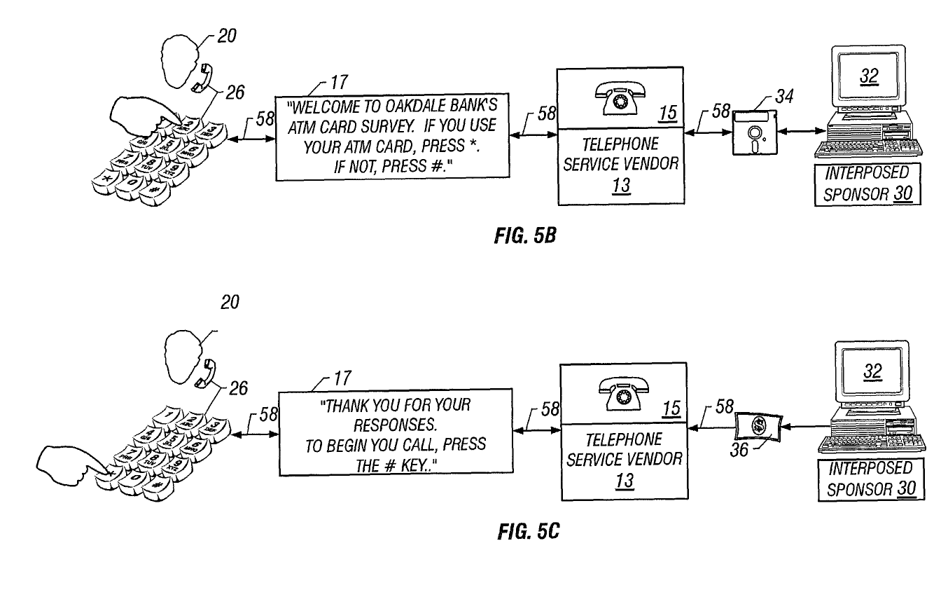

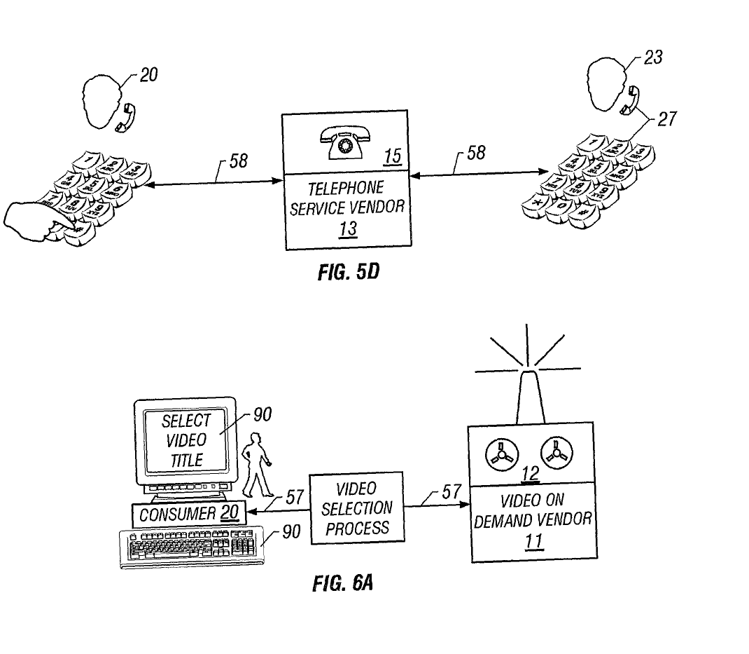

FIGS. 5A through 5D show a method of obtaining/distributing telephone service in accordance with another alternative embodiment of the present invention. Specifically, FIG. 5A shows a telephony network 58, comprising one or more of the following: hardwire telephone system, wireless telephone system, microwave relay, satellite relay, satellite direct system, cable, or internet, to enact a telephone transaction.

In this example, a consumer 20 initiates a collect telephone call on telephone 26, which may be any telephone appliance, owned or unowned by said consumer, located anywhere. The telephone service vendor 13 preferably uses its computer 15 to prompt the consumer to select a payment type (collect or interposed communication) prior to connecting the consumer with consumer's answering party. It is important to note that this is but one example of a myriad of possibilities to use the herein-present invention of an interposed sponsor communication enacting a purchase over a telephony system. Telephone ordering of goods and services from commercial vendors, alternatives to 900 number charges are but two additional embodiments.

FIG. 5B shows that after the consumer has chosen to listen to the interposed commercial, it begins, with the interposed sponsor 30 providing its communication 34 to the consumer via the telephone service vendor 13, in the same manner as previously described in FIG 1D. Consumer 20 may respond to prompts 17 by using telephone 26's number pad. FIG. 5C shows the completion of the interposed communication, and the payment of money to the telephone service vendor in the same manner as previously described in FIG 1F. Finally, FIG. 5D shows the consumer's call being completed to their called party 23, answering the phone using their telephone appliance 27.

As a variation to the specific scenarios of FIGS. 5A-5D, consumers dialing 411 can be given the choice of either paying for directory assistance (billed to their telephone number) or listen to an interposed sponsor's communication, and respond to prompts by utilizing the telephone's number pad. Virtually all pay phone activity could be paid for in this manner, including what might start out as a collect call, with the caller being given the choice—collect or interposed communication. Other services, which can be rendered over the telephone, by telephone marketers, can also benefit from this purchase mechanism. Any number of information services, or purchases of goods or services ordered over the phone can be paid for enabling the interposed sponsored communication.

In the other telephony embodiments, this step may include the delivery of goods and/or services following the completion of the interposed communication, as previously described in FIG. 1G.

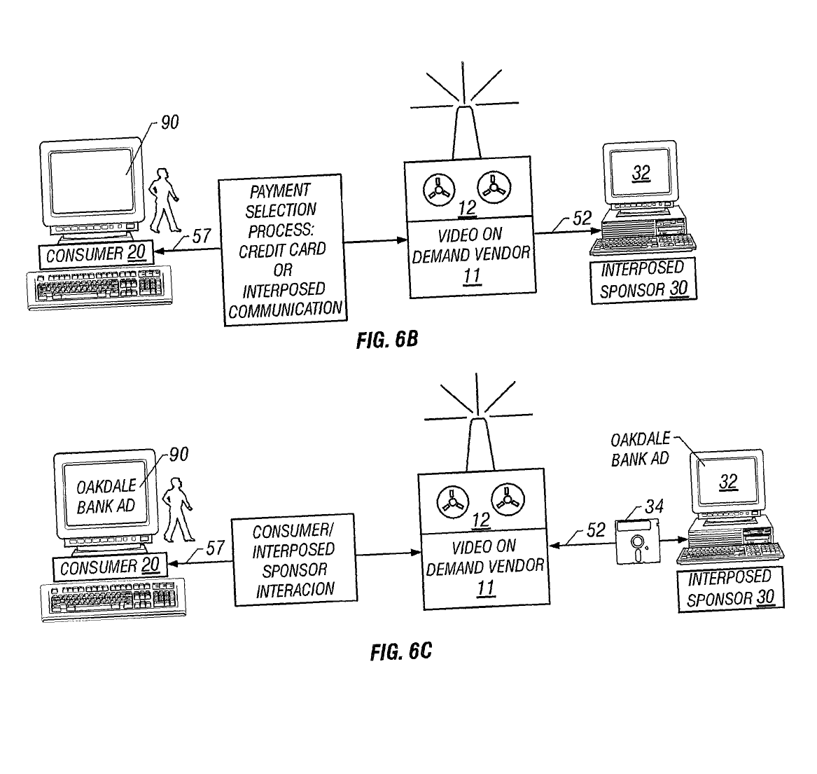

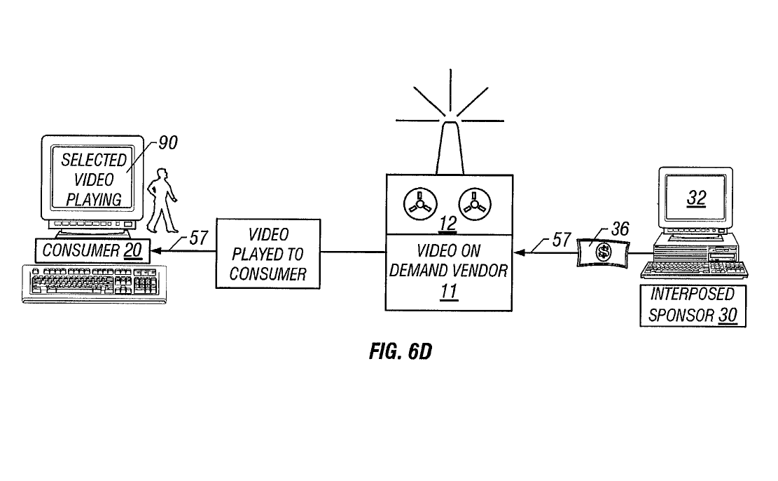

FIGS. 6A-6D shows another alternative embodiment of the present invention wherein a video on-demand vendor 11 offers a consumer 20 the option of paying for a video rental by credit card or interposed communication 34 over a two-way communications network 57 which may be one or more of the following: telephony, internet, CATV, satellite, or other means of two-way communications. Further, a consumer convergence appliance 90, incorporating elements of a television and a computer including a means of inputting specific data, like an alpha-numeric keyboard, and a screen capable of displaying said data and video content, which can communicate over said two-way telecommunications network, and receive video content over a video delivery system 56.

Specifically, FIG. 6A shows the video selection process where consumer may select a video title for viewing or purchasing. FIG. 6B shows the consumer selecting the interposed communication as the payment type, with the interposed sponsor 30 being notified to send its interposed communication 34. This may include all the steps similarly described in FIGS 1D through 1F.

FIG. 6C shows the interposed sponsor 30 providing the interposed communication 34 to the video on-demand vendor 11 by way of a two-way communications path 52 which may be one or more of the following: mail, courier, telephony, facsimile, person-to-person meetings, telecommunications network. consumer receives the communication on his screen from vendor over a two-way communications network 57 and interacts with the communication's prompts. As with all the previously described embodiments, variations in the way the interposed sponsor's communication is selected and delivered is the same as in FIGS. 2A through 2F, and FIGS. 1D through 1F.

Finally, FIG. 6D shows the fulfillment of the consumer's order, in this case the selected video being shown on the consumer's screen and the interposed sponsor paying money 36 to the video on-demand vendor.

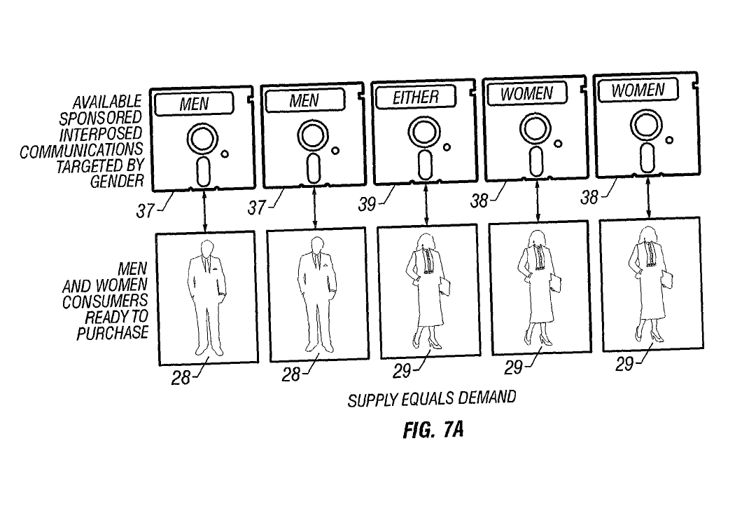

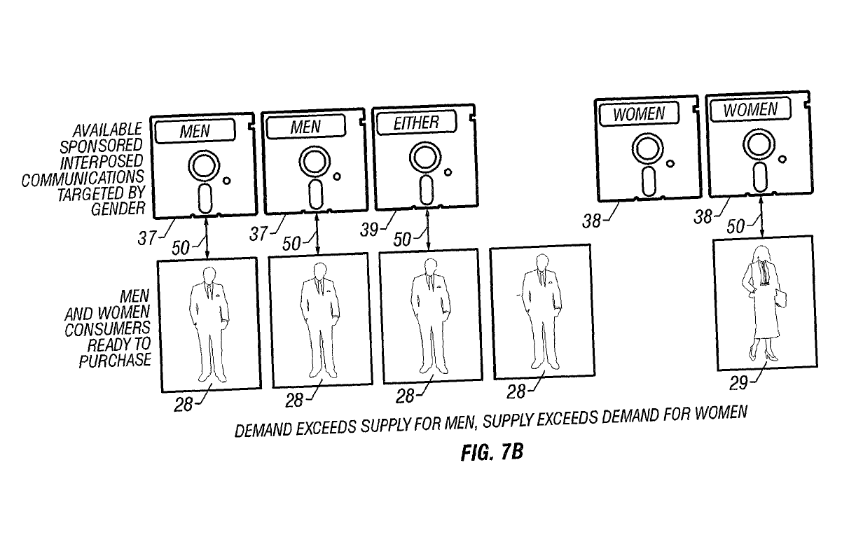

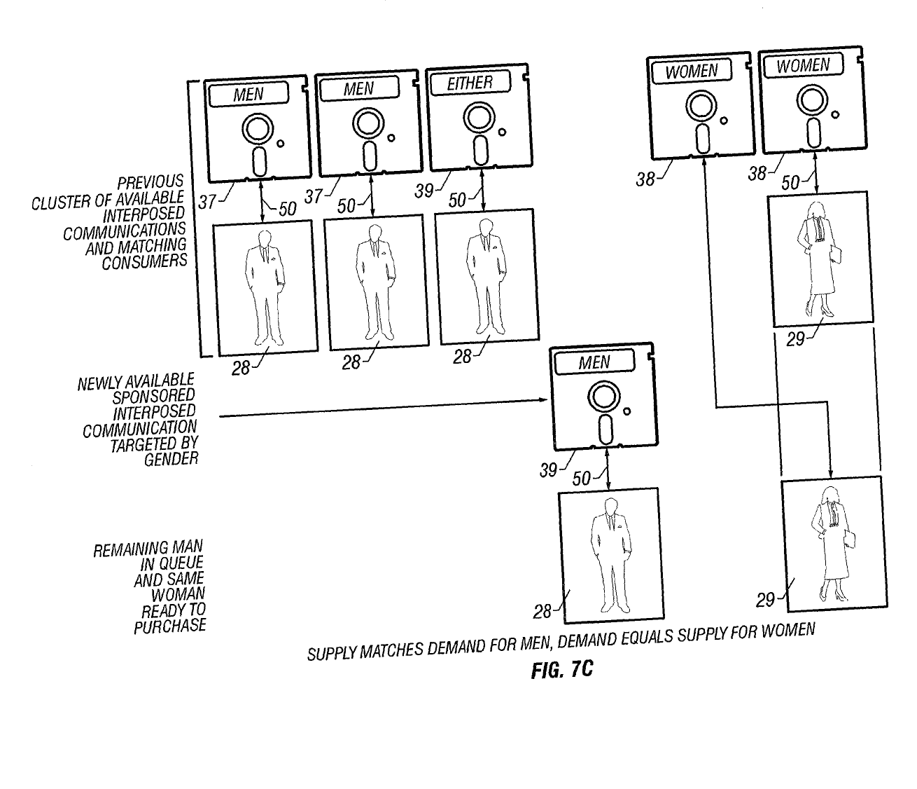

FIGS. 7A through 7C show the supply and demand of available interposed communication and consumers, and how fluctuations in supply and demand are preferably handled. Specifically, FIG. 7A shows an equal supply and demand equation. Available interposed sponsored communications targeted to men 37, women 38 or to either 39 equal the number of men consumers 28 and women consumers 29 ready to make purchases paid for by the above interposed communications. FIG. 7B shows an example of two imbalances in supply and demand: too few interposed communications 37 for men consumers 28 and too many interposed communications 38 for women consumers 29.

FIG. 7C shows a method to correct the imbalances of supply and demand as shown in FIG. 7B. First, all of the interposed communications for men 37 are provided to the first available male consumers 28 over a telecommunications network 50 to enact purchases of goods and/or services, as previously explained in FIGS. 1A through 1G and 2A through 2F. Next, one of the two interposed communications for women 38 is provided for the one woman consumer 29, using the same means in FIGS. 1A through 1G and FIGS. 2A through 2F. Then, as a new interposed sponsored communication for men 37 becomes available, the fourth male consumer 28 receives the communication to enact a purchase as previously described herein. The same woman consumer 29 has an opportunity to make a second purchase by utilizing the second interposed communication 38 in the same manner as described herein.

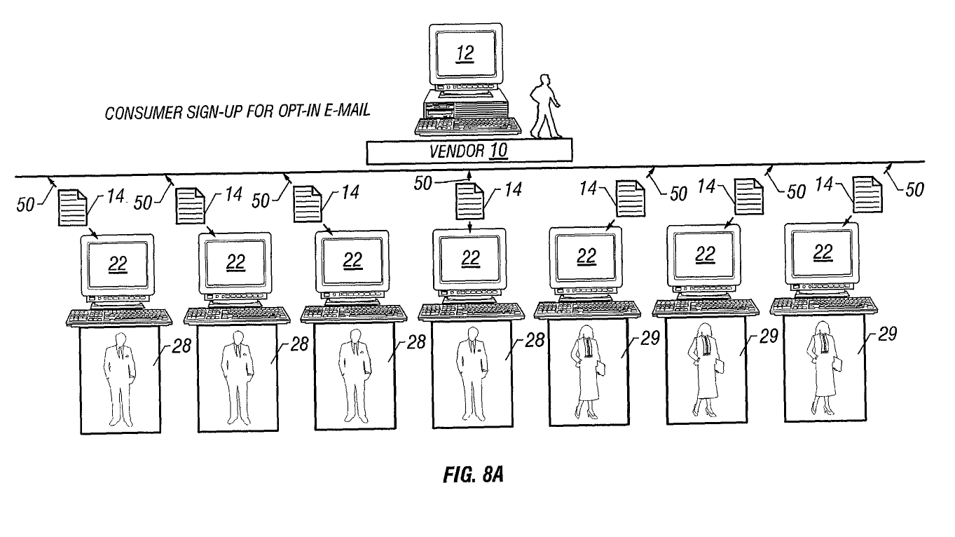

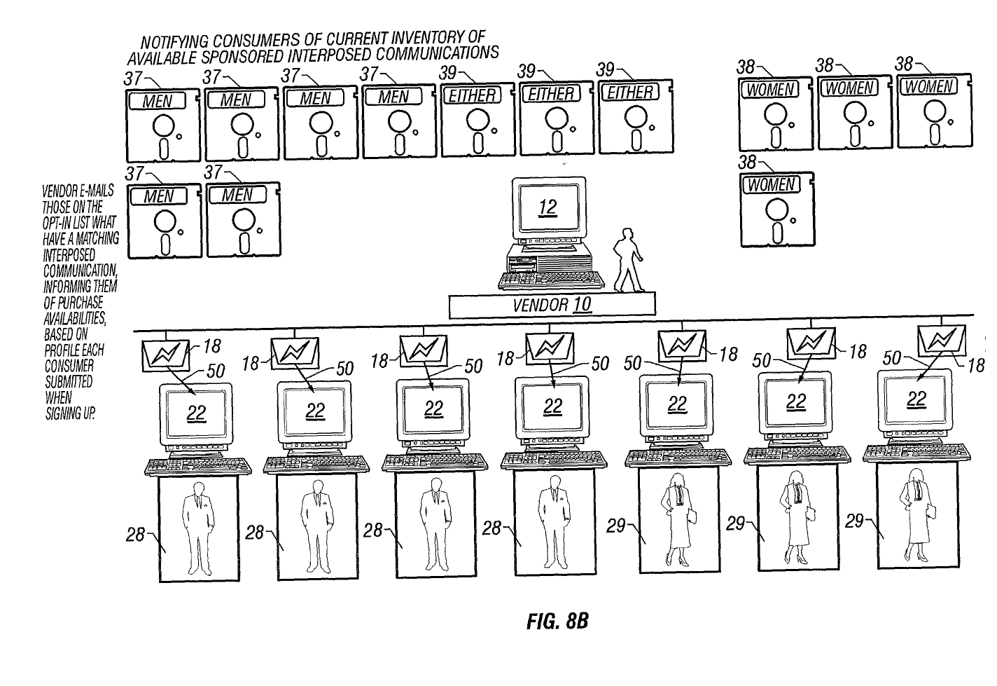

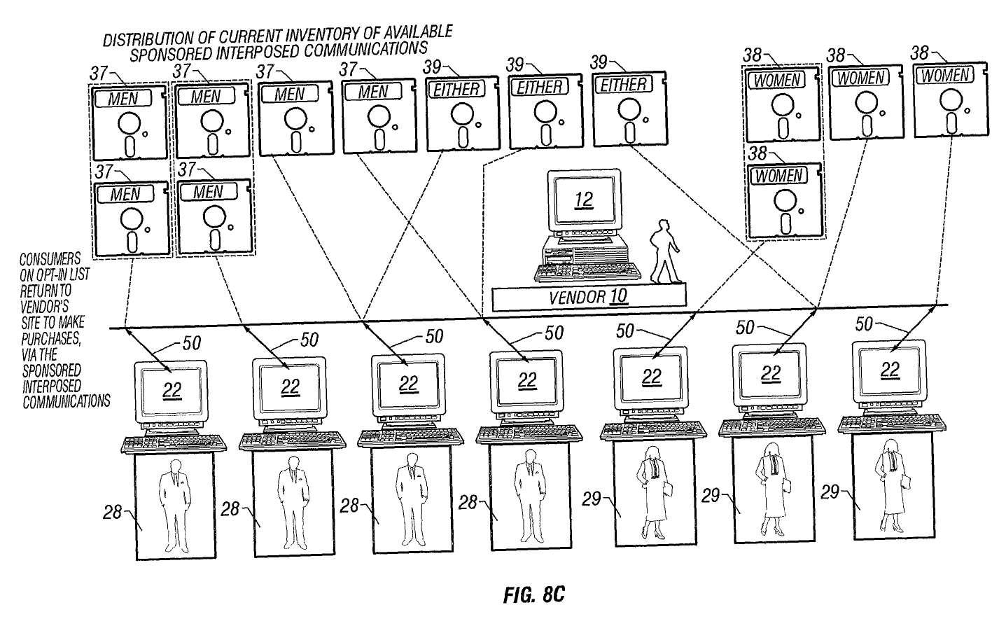

FIGS. 8A through 8C show an additional embodiment of the present invention utilizing an opt-in e-mail model to handle the fluctuations in supply and demand for interposed communications and consumers. Specifically, FIG. 8A shows a vendor 10 offering consumers 28 and 29 an opportunity to sign-up 14 for opt-in e-mails over a telecommunications network 50, which will notify said consumers when interposed communications 37, 38, and 39 are available to enact purchases.

FIG. 8B shows that when vendor 10 has an interposed communication 37, 38, or 39, that matches consumers who have signed up for the opt-in e-mail, the vendor then sends over a telecommunications network 50 an e-mail 18 to those said consumers 28, 29. As noted in the text within FIG. 8B, the profile included with the sign-up mechanism enables the vendor to route the interposed communications to those consumers matching the sponsor's criteria, in this example, gender. As new interposed communications become available to any defined consumer group, e-mails are sent out to ask them to return to the site to make purchases. Finally, FIG. 8C shows the distribution of the interposed communication inventory, as the consumers 28 and 29 return to the vendor's site 12 to enact purchases utilizing the interposed communications 37, 38 and 39.

FIGS. 9A-1 through 9B-3 show an additional embodiment of the present invention wherein an interposed communication distributor 80 receives consumer sign-up profiles 14 from various affiliate vendors 10 and then distributes interposed communications 37, 38, 39 to consumers 28, 29 as said consumers make purchases from said vendors.

Specifically, FIG. 9A-1 through FIG. 9A-3 shows consumers 28, 29 providing various affiliate vendor sites with completed sign-up profiles 14, which are transmitted over a telecommunications network 50 to an interposed communication distributor 80. This distributor utilizes the large number of consumers and affiliate vendor sites to attract large numbers of advertisers wishing to reach many different market segments, without duplication. The consumer sign-up profiles 14 allow the distributor to see if any duplicated consumers exist. FIG. 9B-1 through 9B-3 shows that the interposed communications 37, 38 and 39 are distributed across the network 50 to various affiliate vendors 10 to their various consumers 28 and 29, based in this example on gender.

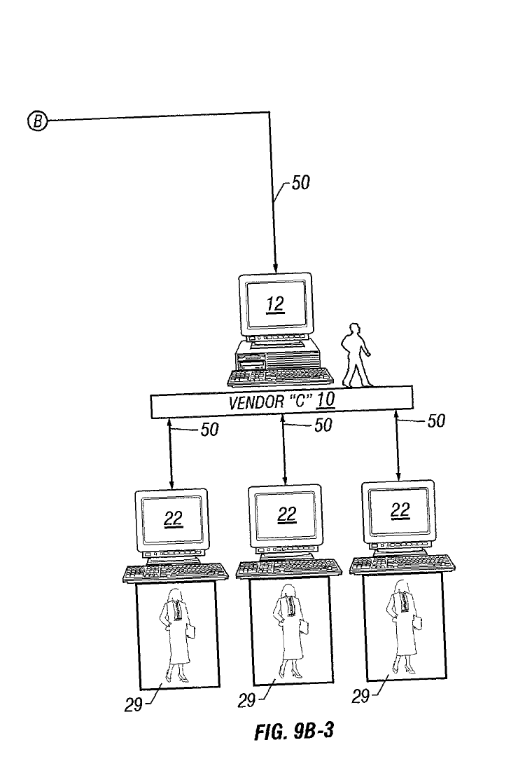

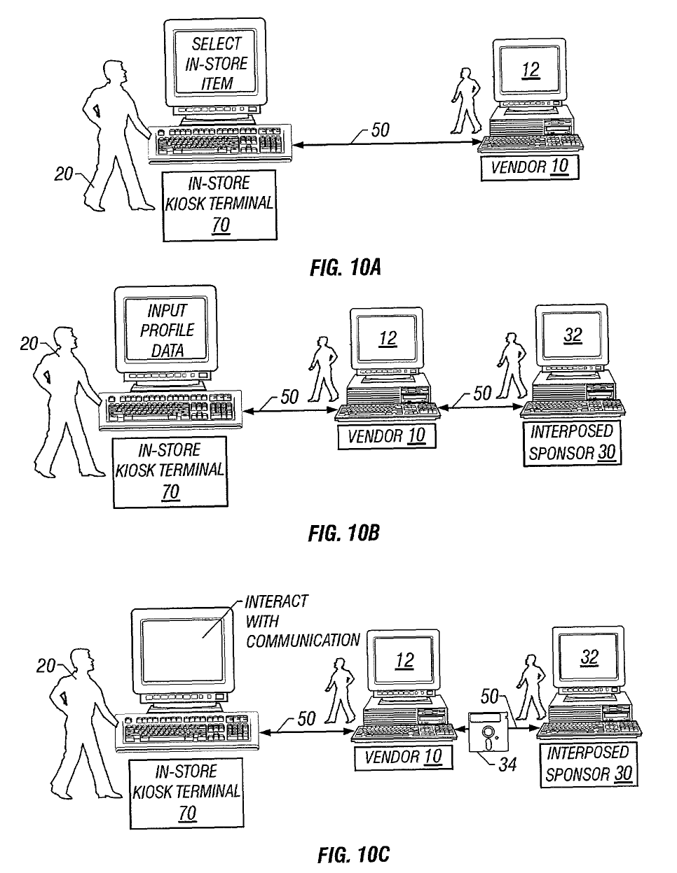

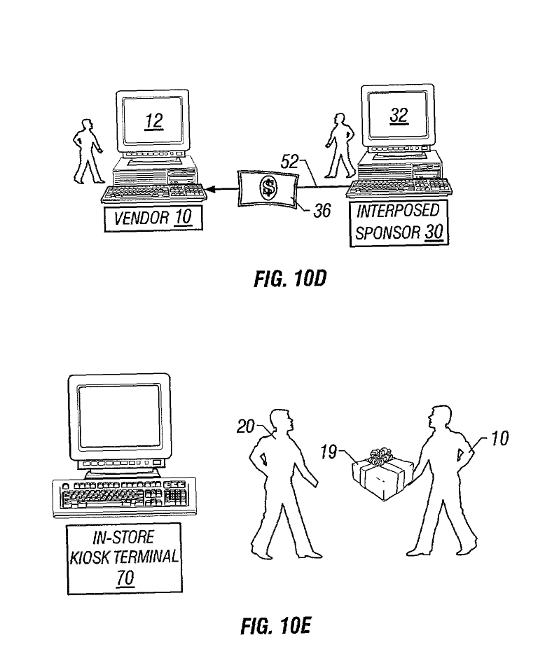

FIGS. 10A through 10E show a further embodiment of the present invention wherein the consumer's computer can even be owned by the vendor, even located in the vendor's physical store. Specifically, FIG. 10A shows an in-store kiosk computer terminal 70, with a walk-up consumer 20 wishing to enact a purchase with vendor 20. The walk-in consumer selects an item on the kiosk, with the vendor's computer 12 making note of the item for inventory control and availability within the particular store the customer is in. The vendor's computer may not be physically located in the store. Perhaps it is at a central office or warehouse.

FIG. 10B shows consumer inputting sign-up profile data as explained in FIGS. 2B through 2C. Vendor 10 selects most appropriate available interposed sponsor 30. FIG. 10C shows the consumer 20 interacting with the sponsor's interposed communication 34 over a telecommunications network 50, as more fully explained in FIGS. 1D through 1F. FIG. 10D shows the interposed sponsor 30 paying money 36 to the vendor 10, as similarly explained in FIG. 1f. Finally, FIG. 10E shows vendor 10 handing the walk-in consumer 20 the goods or services 19 that the consumer selected back in FIG. 10A.

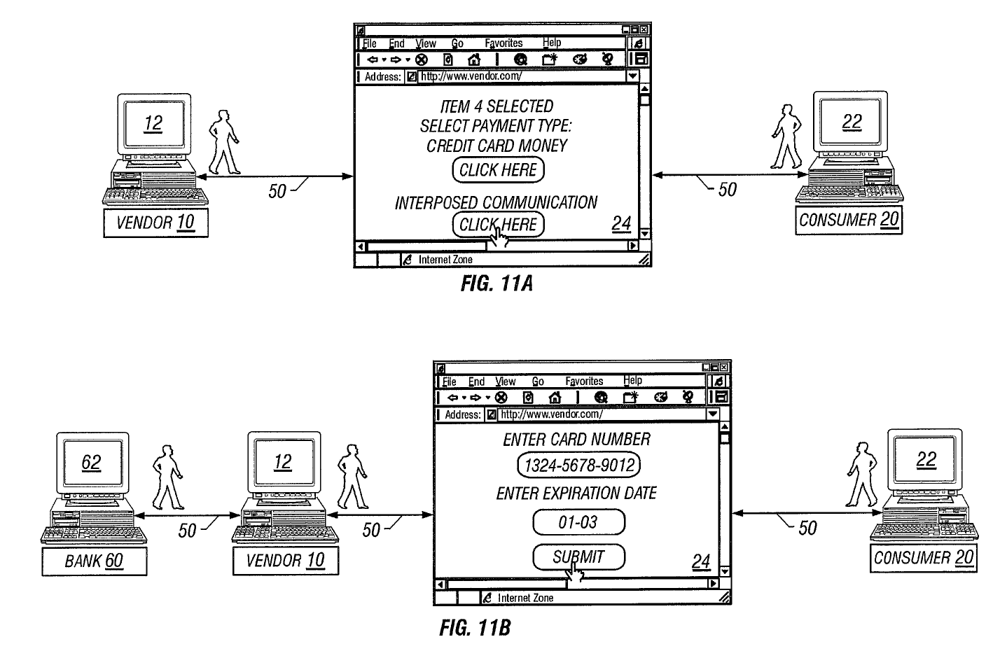

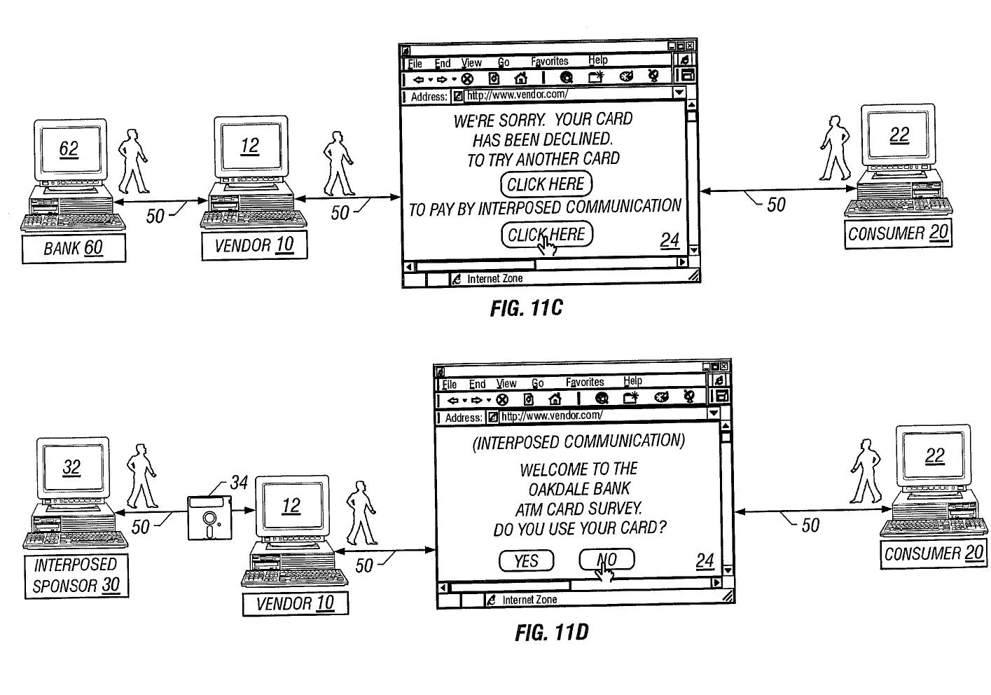

FIGS. 11A through 11D show a contingency plan wherein if consumer 20 at first selects a credit card payment which is declined by a bank 60, said consumer then selects an interposed communication 34 as payment. Specifically, FIG. 11A shows consumer 20 selecting credit card payment instead of interposed communication. FIG. 11B shows consumer inputting their card data, which is sent over a telecommunications network 50 (with a Secure Socket Location) to the vendor's bank 60, which checks the data to see if the card is valid and has sufficient credit left to enact the purchase. FIG. 11C shows that the card, in the example, is declined, as shown on the consumer's browser window 24. Also shown on this window is the opportunity to select another card or select the interposed communication as payment. In this example the consumer selects the interposed communication. Finally, FIG. 11D shows the interposed sponsor's communication 34 being sent to the consumer for responses to prompts as previously outlined in detail in FIGS. 1D through 1F.

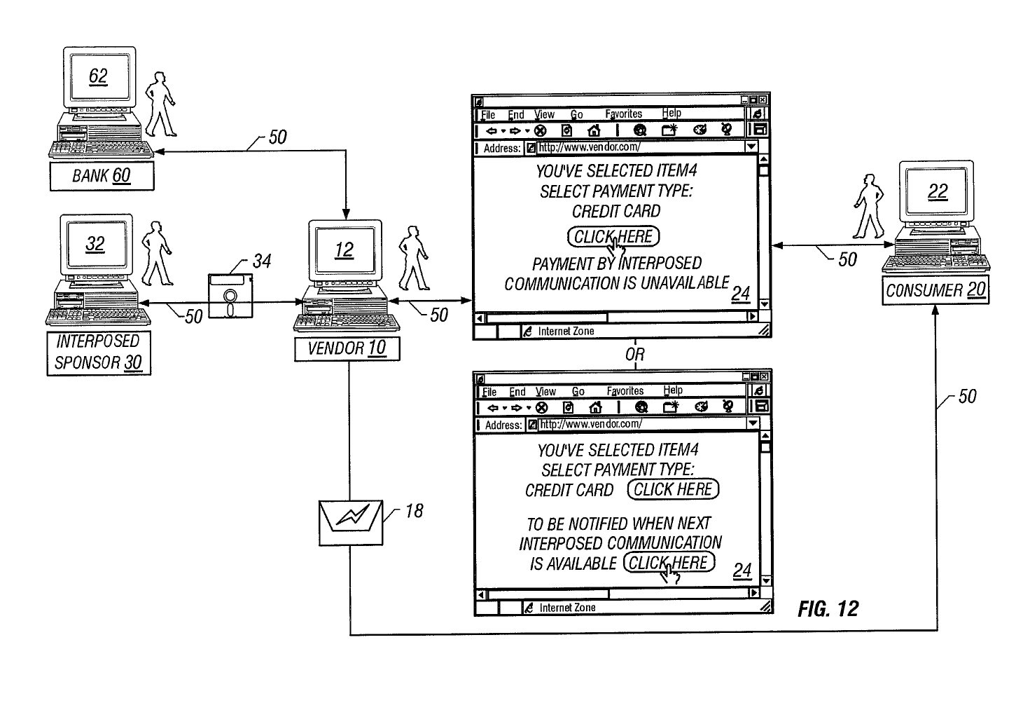

FIG. 12 shows two contingency plans if an interposed sponsor's 30 interposed communication 34 is not available to enact a purchase. The first example informs the consumer 20 that the interposed communication 34 is not available, offering only a credit card as a purchasing choice. In the second example, below the “OR”, the consumer 20 is offered the choice of credit card payment or notification by vendor 10 by e-mail when an interposed communication 34 will be available for purchase of selected item.

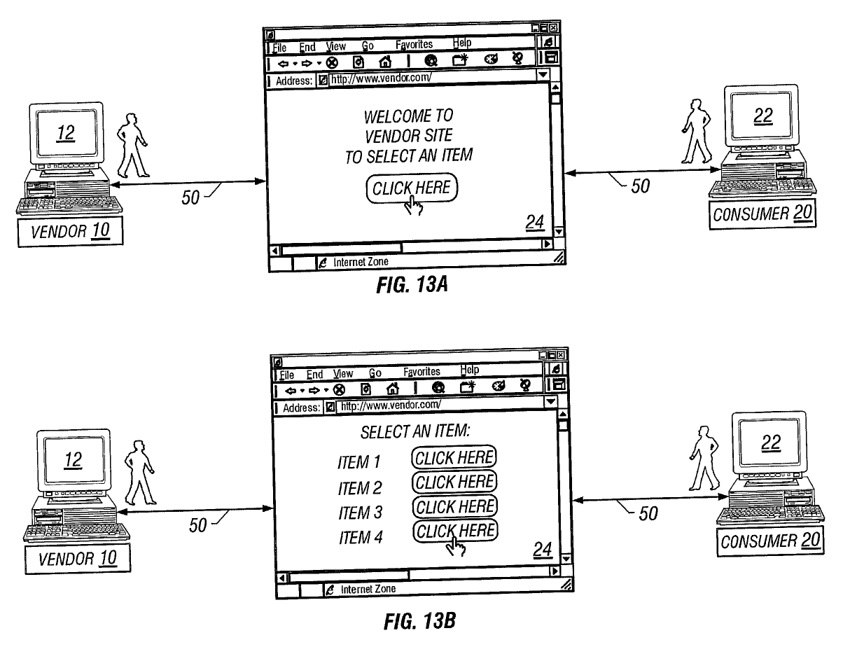

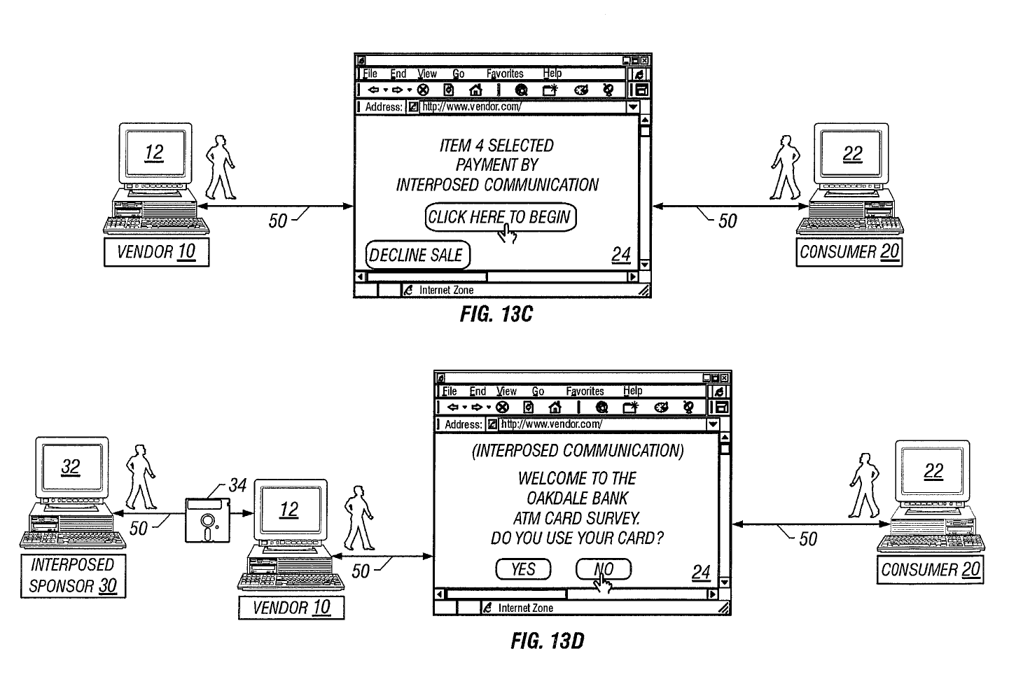

FIGS. 13A through 13D show an additional embodiment of the present invention wherein the only choice for payment is the sponsored interposed communication. Specifically, FIG. 13A shows the consumer 20 being requested to select an item from a vendor's 10 site 12. FIG. 13B shows the consumer 20 selecting Item 4 from the list displayed on the browser screen 24. FIG. 13C shows that the vendor 10 is confirming consumer's 20 choice of Item 4, and prompting consumer to pay for Item 4 by beginning sponsored interposed communication 34. The consumer has selected the interposed communication. Finally, FIG. 13D shows the consumer 20 interacting with the sponsor's 30 interposed communication 34.

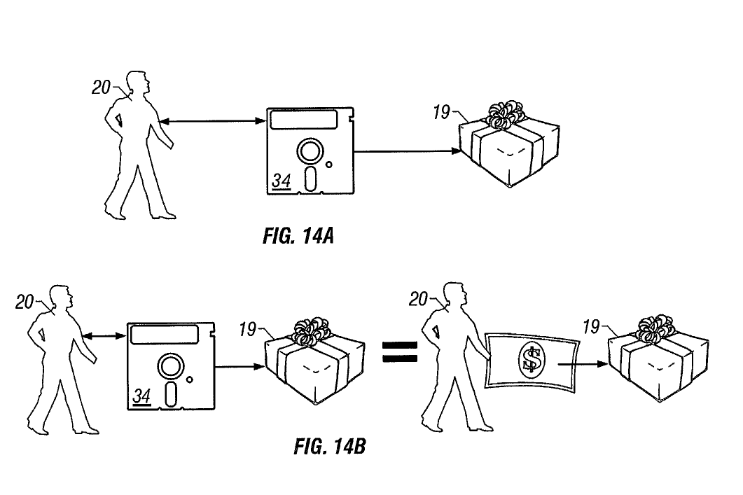

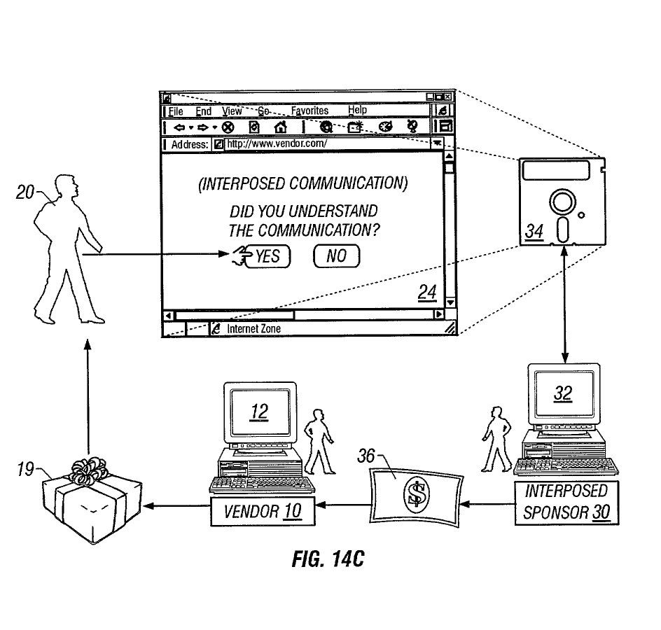

FIGS. 14A through 14C show the specific minimum qualities the sponsored interposed communication may preferably include. Specifically, FIG. 14A shows the consumer 20 interacting with the sponsored interposed communication 34. Further, goods and/or services 19 that the consumer 20 wishes to receive from interacting with the interposed communication 34 is connected to same, representing the direct connection the sponsored interposed communication has to what the consumer wants.

FIG. 14B suggests that interacting with the sponsored interposed communication 34 to acquire goods and/or services 19 is equivalent to the act of purchasing the same goods and/or services. Accordingly, the sponsored interposed communication is a purchase enabler.

Finally, FIG. 14C shows that the sponsored interposed communication 34 preferably includes at least one prompt for a response from the consumer 20 in order to justify why the sponsor 30 is paying monies 36 for the goods and/or services 19 to the vendor 10, on behalf of the consumer 20. One advantage of the present invention is to provide a sponsor with evidence that their interposed communication is indeed being viewed and/or listened to, and that that proof comes from asking the consumer questions during the interposed communication, and receiving answers to those questions from that consumer during that time.

Because the interposed communication has interaction, the advertiser can now receive real-time feedback from the consumer. And with herein-described information-gathering systems, the vendor can know in advance certain information about the consumer (age range, sex, zip code, etc.) which enables the vendor to provide more closely the type of consumer the sponsor wants to reach. This is worth a premium to the sponsor. The opportunity for much less waste in targeting consumers is available. This further enhances the profitability for the vendor, and, as the vendor's rates to sponsors go up, so do the number of goods and services that become economically viable to sell.

In other embodiments of the present invention, vendors can provide discount on goods and services, where, although the value of the interposed communication is insufficient to pay for the goods and services in their entirety, the interposed communication can afford a discount on the final price. Perhaps discounts on movie tickets purchased online or over the phone.

From the discussions above, a number of advantages of the present invention become evident:

a) A consumer can receive goods and services, without having to have a credit card, ATM card, checking account, or cash of any kind. Young people under the age of 18 are particularly helped by this method. They become empowered;

b) Many items now offered at no charge on the Internet could be offered for sale through this sponsored interposed communication. Examples: shareware programs, search engine results, subscriptions to news sites. This could help many commercial sites become profitable;

c) Any of the negative issues involving on-line credit card transactions become substantially irrelevant;

d) Consumers of all ages can legitimately receive goods and services without spending cash, making the experience “feel” free. In the current Internet climate, where music, literature, information and software are being freely traded on peer-to-peer sites without payment for these copyrighted goods, the invention described herein offers a payment method as close to “free” as is possible;

e) Because this invention can be scaled in financial value, it becomes possible to pay for many small items with one interposed communication—or—by viewing several interposed communications, pay for larger-priced items. Recurring interposed communications could offer a subscription payment model to fund online trading sites, supplying a revenue stream to copyright holders and site owners alike; and

f) Sponsors get a much higher attention to their messages as consumers can be required to respond to sponsor's questions during an interposed communication. This becomes an excellent way for marketers to “test-market” a new product, or run a movie trailer for an upcoming feature, and ask the consumer for immediate feedback.

Although the above detailed discussions contain many specific examples, these details should not be construed as limitations on the scope of the present invention, but rather as exemplification of certain embodiments thereof. Other variations are possible. Accordingly, the scope of the present invention should be determined not by the embodiments illustrated, but by the appended claims and their legal equivalents, as put forth hereinafter.

What I claim:

1. A method for offering incentives related to purchases of products or services, said method comprising the steps of:
offering to a consumer a product or a service for sale;
offering to said consumer an incentive related to the purchase of said product or service on condition that the consumer agrees to receive or interact with an interposed communication; and
providing the offered incentive.

2. The method according to claim 1, wherein said incentive is provided to said consumer after an interposed communication is delivered to said consumer.

3. The method according to claim 1, wherein said incentive includes a discount on the purchase of said product or service.

4. The method according to claim 1, wherein said incentive includes paying for shipping charges related to the purchase of said product or service.

5. The method according to claim 1, wherein said incentive is providing the offered product or service free of charge.

6. The method according to claim 1, wherein said incentive includes providing information to said consumer.

7. The method according to claim 1, wherein said incentive includes free telephone service.

8. The method according to claim 1, wherein said incentive includes free video on demand.

9. The method according to claim 1, wherein said incentive includes in-store coupons.

10. The method according to claim 1, wherein said interposed communication is a multimedia presentation.

11. The method according to claim 1, wherein said interposed communication is an interactive survey.

12. The method according to claim 1, wherein said interposed communication is an audio message.

13. The method according to claim 1, wherein said interposed communication is a visual display.

14. The method according to claim 1, wherein said interposed communication is a link to an Internet web site.

15. The method according to claim 1, further comprising the step of selecting an interposed communication for delivering to said consumer.

16. The method according to claim 1, further comprising the step of delivering to said consumer the interposed communication.

17. The method according to claim 1, further comprising the step of requesting said consumer to provide identification information.

18. The method according to claim 17, wherein said identification information includes said consumer's e-mail address.

19. The method according to claim 17, wherein said identification information includes said consumer's address information.

20. The method according to claim 17, wherein said identification information includes said consumer's gender.

21. The method according to claim 17, wherein said identification information includes said consumer's age.

22. The method according to claim 1, further comprising the step of maintaining a database of interpose communications.

23. The method according to claim 1, further comprising the step of collecting payment from an interposed sponsor.

24. The method according to claim 1, further comprising the step of making payment to a vendor.

25. The method according to claim 1, wherein said product or service is downloadable from the Internet by the consumer.

26. The method according to claim 1, wherein said interposed communication is delivered over a communications network.

27. The method according to claim 1, wherein said interposed communication is delivered via a stand-alone device.

28. A method for obtaining incentives related to purchases or products or services, said method comprising the steps of:
selecting a product or service for purchase;
obtaining an incentive related to the purchase of the selected product or service by agreeing to view an interposed communication;
receive an interposed communication;
receive said incentive.

29. The method according to claim 28, wherein said incentive includes a discount on the purchase of said selected product or service.

30. The method according to claim 28, wherein said incentive includes free delivery of the purchased product or service.

31. The method according to claim 28, wherein said incentive includes receiving the selected product or service free of charge.

32. The method according to claim 28, wherein said incentive includes receiving information.

33. The method according to claim 28, wherein said incentive includes free telephone service.

34. The method according to claim 28, wherein said incentive includes free entertainment video on demand.

35. The method according to claim 28, wherein said incentive includes instore coupons.

36. The method according to claim 28, wherein said interposed communication is a multimedia presentation.

37. The method according to claim 28, wherein said interposed communication is an interactive survey.

38. The method according to claim 28, wherein said interposed communication is an audio message.

39. The method according to claim 28, wherein said interposed communication is a visual display.

40. The method according to claim 28, wherein said interposed communication is a link to an Internet web site.

41. The method according to claim 28, further comprising the step of providing personal identification information.

42. The method according to claim 28, further comprising the step of downloading said selected product or service.

43. The method according to claim 28, wherein said interposed communication is delivered over a communications network.

44. The method according to claim 28, wherein said interposed communication is delivered via a stand-alone device.
